(19) United States
(12) Patent Application Publication
(10) Pub. No.: US 2025/0354225 A1
(43) Pub. Date: Nov. 20, 2025

(54) COMBUSTION CHAMBER COMPRISING A MODULAR REFRACTORY SIDEWALL AND REFRACTORY PANEL FOR THE SAME

(71) Applicant: LES ÉQUIPEMENTS LAPIERRE INC., Saint-Ludger (CA)

(72) Inventors: Luc BRIÈRE, Saint-Ludger (CA); Gabriel BOUCHER, Saint-Ludger (CA); Jean-Claude GRANGER, Saint-Ludger (CA)

(73) Assignee: LES ÉQUIPEMENTS LAPIERRE INC., Saint-Ludger (CA)

(21) Appl. No.: 19/209,206

(22) Filed: May 15, 2025

Related U.S. Application Data
(60) Provisional application No. 63/648,402, filed on May 16, 2024.

(51) Int. Cl. C13B 25/04; F23M 5/02; F23M 5/04

(52) U.S. Cl. CPC C13B 25/04; F23M 5/02; F23M 5/04; F23M 2700/005

(57) ABSTRACT

A combustion chamber for an evaporator configured for the production of a syrup, the combustion chamber comprising a combustion chamber frame defining a firebox configured to receive a fuel for combustion, and a modular refractory chamber wall extending along a longitudinal side of the firebox, the modular refractory chamber wall comprising at least one refractory panel removably mountable to the combustion chamber frame to provide a thermal insulation to the combustion chamber.

### TECHNICAL FIELD

The technical field relates to equipment for the production of a syrup, and more specifically to a combustion chamber for the production of a syrup.

### BACKGROUND

In the production of syrups, including for instance maple syrup, an evaporator is used to increase the sugar concentration of the syrup up to a suitable level by evaporating the excess water contained within the sap. For instance, in the production of maple syrup, an evaporator can be used to increase the sugar concentration of the maple syrup up to a level of about 66° on the Brix scale. The evaporator may further serve to cook the sugar, transforming it into syrup.

To carry out this task, the evaporator typically includes a combustion chamber providing a heat source. This source may be electric or provided by the combustion of a fuel within a firebox of the combustion chamber including, for example, a fossil fuel or a biomass provided in the form of firewood, for instance.

When biomass is used as fuel within the combustion chamber, the floor and walls of the combustion chamber may be made of refractory materials, in order to withstand combustion and reflect the radiant heat produced by the combustion, back toward the combustion. In addition, these refractory materials may be of a material capable of withstanding the impact of logs thrown into the combustion chamber.

In practice, refractory bricks are typically cemented together with mortar to construct sidewalls of the combustion chamber. In such instances, the construction of the combustion chamber can be a laborious process that can take up to several days for a skilled worker. Moreover, while the refractory quality of the refractory bricks is suitable for this application, their mechanical qualities (i.e., resistance to log impacts and crumbling) are often suboptimal thus requiring the frequent replacement of damaged refractory bricks. In some instances, the replacement of damaged refractory bricks may require dismantling a significant number of bricks in order to reach the one that requires replacement. This repair process is disadvantageous for several reasons including, for instance, loss of time, loss of productivity, increased maintenance and/or replacement costs.

Accordingly, there remain a number of challenges with respect to the construction of a combustion chamber within an evaporator for the production of a syrup and, more specifically, with the construction of the refractory bricks.

### SUMMARY

In accordance with an aspect, there is provided a combustion chamber for an evaporator for the production of a syrup, the combustion chamber comprising a combustion chamber frame defining a firebox configured to receive a fuel, and a modular refractory chamber wall extending along a longitudinal side of the firebox, the modular refractory chamber wall comprising at least one refractory panel removably mountable to the combustion chamber frame to provide a thermal insulation to the combustion chamber.

In certain embodiments, the combustion chamber further comprises a resilient member insertable between a surface of the at least one refractory panel and an opposing surface of the combustion chamber frame when the at least one refractory panel is mounted to the combustion chamber frame to retain the at least one refractory panel in a mounted configuration.

In certain embodiments, the resilient member is insertable between an upper side face of the at least one refractory panel and an upper lip of the combustion chamber frame.

In certain embodiments, when the combustion chamber is assembled, the resilient member is compressible to release the at least one refractory panel from the combustion chamber frame.

In certain embodiments, the modular refractory chamber wall comprises a plurality of refractory panels configured to be removably mounted to the combustion chamber frame in an adjacent configuration.

In certain embodiments, the modular refractory chamber wall is a first modular refractory chamber wall, and the longitudinal side of the firebox is a first longitudinal side of the firebox, the combustion chamber further comprising a second modular refractory chamber wall extending along a second longitudinal side of the firebox opposite the first longitudinal side of the firebox.

In certain embodiments, the combustion chamber frame comprises a sidewall configured to mountingly receive the modular refractory chamber wall.

In certain embodiments, the sidewall of the combustion chamber frame comprises an inner sidewall and an outer sidewall, the at least one refractory panel being removably mountable to the inner sidewall.

In certain embodiments, the sidewall defines a panel-receiving recess sized to receive the at least one refractory panel of the modular refractory chamber wall.

In certain embodiments, the panel-receiving recess extends over a majority of a height of the sidewall of the combustion chamber frame.

In certain embodiments, the panel-receiving recess is shaped to receive the at least one refractory panel of the modular refractory chamber wall in an inclined configuration.

In certain embodiments, the at least one refractory panel is a silica-alumina composite.

In certain embodiments, the at least one refractory panel comprises at least 40% by weight of alumina.

In certain embodiments, the at least one refractory panel is a silica-alumina composite further comprising at least one of iron oxide and lime.

In certain embodiments, the at least one refractory panel has a permanent linear change of about 0.1 to −1.1% after heating to 2300° F. according to ASTM C-401 (Class B).

In certain embodiments, the combustion chamber further comprises a transverse refractory panel removably mountable to the combustion chamber frame at a distal end of the firebox of the combustion chamber frame to provide a secondary thermal insulation to the combustion chamber.

In certain embodiments, the transverse refractory panel comprises a handle extending upwardly to facilitate a removal of the transverse refractory panel from the combustion chamber.

In certain embodiments, the transverse refractory panel extends a width of the firebox when mounted to the combustion chamber frame.

In certain embodiments, the transverse refractory panel is positioned beneath an air inlet of the combustion chamber frame when the transverse refractory panel is mounted to the combustion chamber frame.

In accordance with an aspect, there is provided a refractory panel configured for installation in the combustion chamber as provided above.

In accordance with another aspect, there is provided a method of installing a modular refractory chamber wall in a combustion chamber of an evaporator, the method comprising removably mounting a refractory panel of the modular refractory chamber wall to a combustion chamber frame of the combustion chamber, and inserting a resilient member between the refractory panel and the combustion chamber frame to retain the refractory panel in a mounted configuration

### BRIEF DESCRIPTION OF THE DRAWINGS

The attached figures illustrate various features, aspects and implementations of the technology described herein.

FIG. 1 is a top perspective view of a combustion chamber, in accordance with an embodiment.

FIG. 2 is an exploded top perspective view of the combustion chamber of FIG. 1.

FIG. 3 is a top plan view of the combustion chamber of FIG. 1.

FIG. 4 is bottom plan view of the combustion chamber of FIG. 1.

FIG. 5 is a front elevation view of the combustion chamber of FIG. 1.

FIG. 6 is a right elevation view of the combustion chamber of FIG. 1.

FIG. 7 is a left elevation view of the combustion chamber of FIG. 1.

FIG. 8 is a rear elevation view of the combustion chamber of FIG. 1.

FIG. 9 is a top perspective view of a refractory panel of the combustion chamber of FIG. 1.

FIG. 10 is a top perspective view of a transverse refractory panel of the combustion chamber of FIG. 1.

### DETAILED DESCRIPTION

Techniques described herein relate to systems, devices and methods for facilitating an installation and/or a repair of a combustion chamber of an evaporator.

In certain embodiments, it can be desirable to facilitate the installation and/or repair of a combustion chamber by providing a refractory wall without requiring the removal of mortar typically used during the installation of refractory bricks. The installation and/or repair of the refractory wall can be facilitated by providing a modular refractory chamber wall comprising one or more refractory panels removably mountable to a combustion chamber frame of the combustion chamber. Configured in this manner, the combustion chamber of the evaporator may be installed and/or repaired within a substantially reduced period (i.e., within a period of minutes or hours rather than a period of days).

It will be appreciated that positional descriptions such as “above”, “below”, “left”, “right”, “inwardly”, “outwardly” and the like should, unless otherwise indicated, be taken in the context of the figures, and should not be considered limiting. The term “outwardly” is intended to refer to a feature that extends toward an exterior side of a reference axis. The term “inwardly” is intended to refer to a feature that extends toward an interior side of a reference axis. It should also be understood that elongated objects described herein are considered to have an implicit “longitudinal axis” and “lateral axis”. The expression “longitudinal axis” is intended to refer to an axis extending along the length of the object, and the expression “lateral axis” is intended to refer to an axis extending perpendicularly to the longitudinal axis, along the width of the object. When referring to a longitudinal direction, it is intended to refer to a direction that extends substantially parallel to the longitudinal axis of the object, encompassing as well as directions that deviate slightly from the longitudinal axis. When referring to a lateral direction, it is intended to refer to a direction that extends substantially parallel to the lateral axis of the object, encompassing as well as directions that deviate slightly from the lateral axis.

Various implementations and features of the combustion chamber will now be described in greater detail in the following paragraphs.

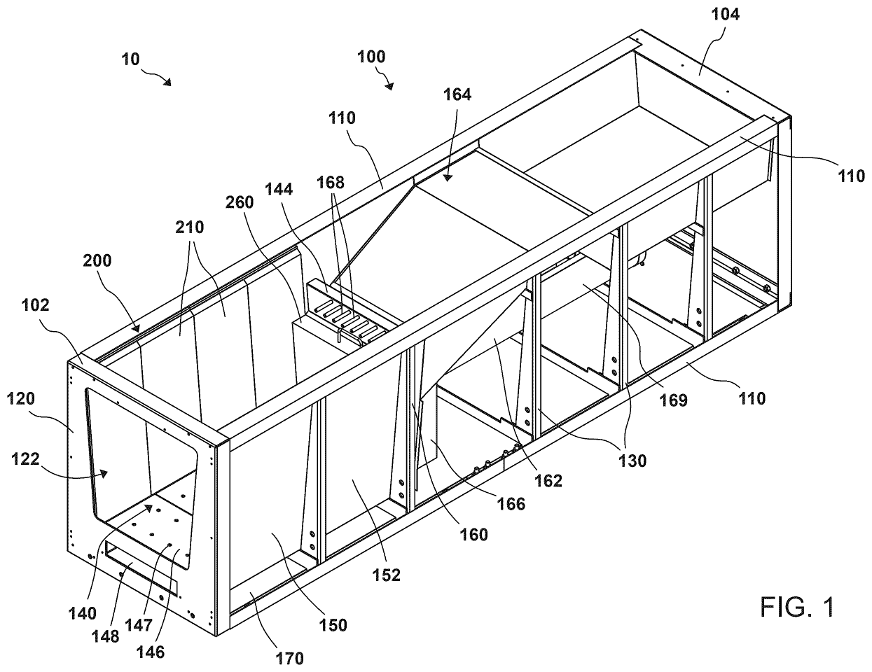

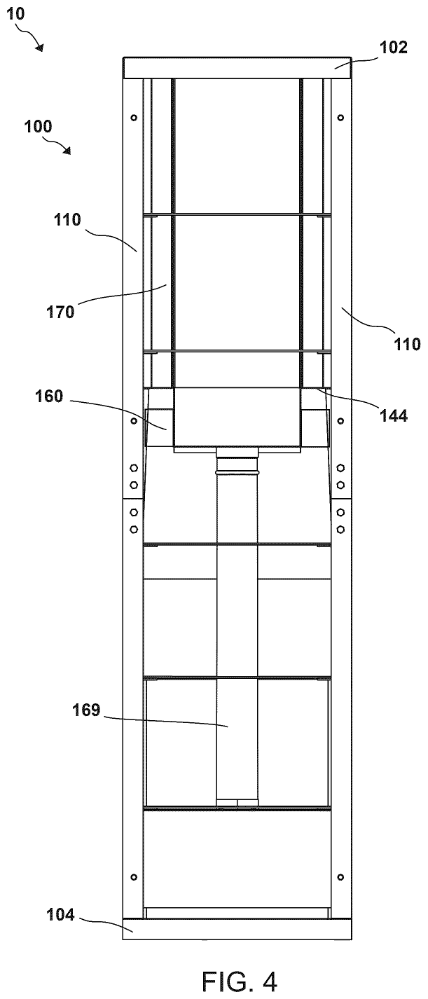

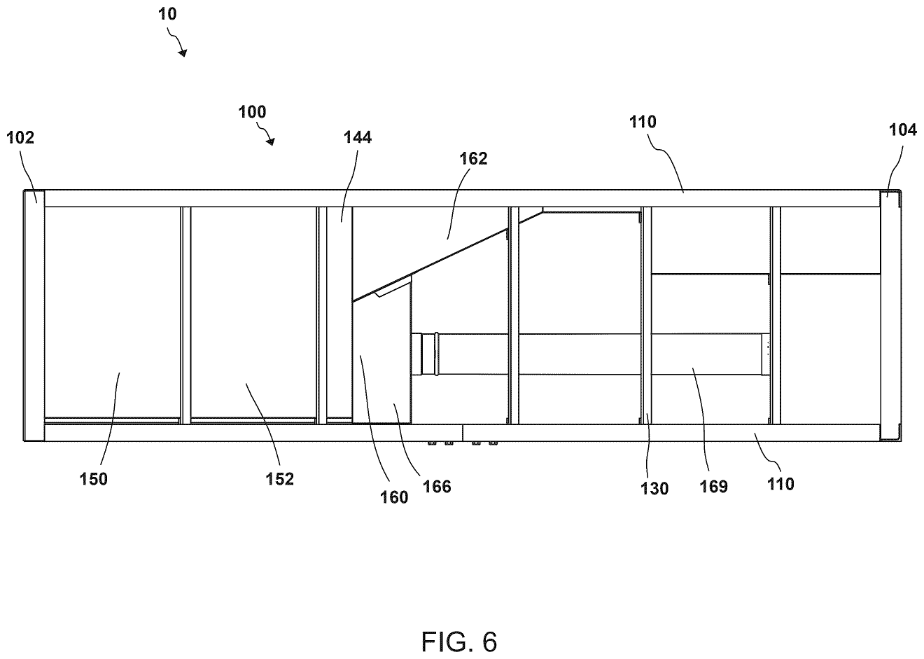

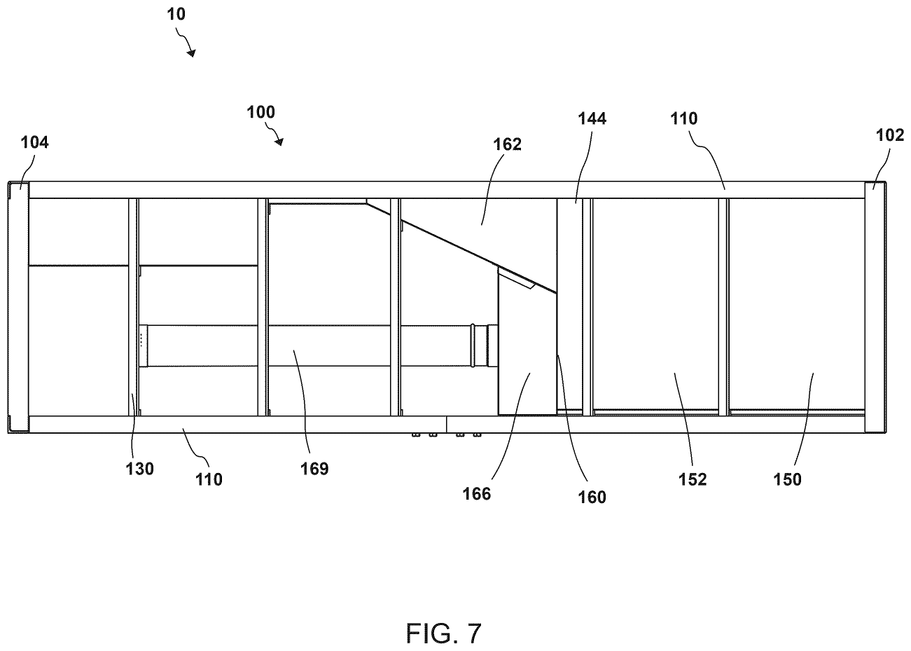

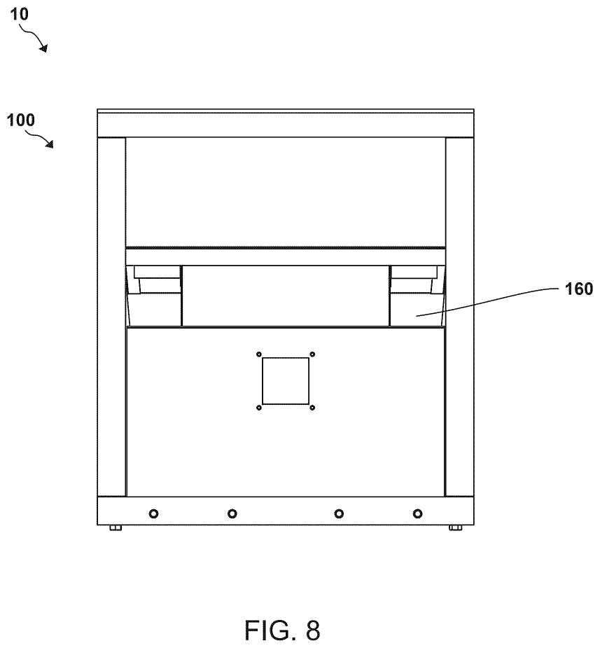

Referring to FIGS. 1 to 8, a combustion chamber 10 configured to combust a fuel for heat generation in an evaporator is illustrated. The evaporator can be used for the production of maple syrup, fruit syrups, corn syrup, sweetener syrups, concentrates, herbal syrups, or the like. Broadly, the combustion chamber 10 includes a combustion chamber frame 100 and a modular refractory chamber wall 200 configured to be removably mounted to the combustion chamber frame 100, as will be described in greater detail below.

In the illustrated embodiment, the combustion chamber frame 100 includes four structural beams 110 extending longitudinally between a proximal end 102 and a distal end 104 of the combustion chamber frame 100, a door panel 120 secured to the structural beams 110 at the proximal end 102 of the combustion chamber frame 100, and a plurality of support columns 130 extending between upper and lower ones of the structural beams 110.

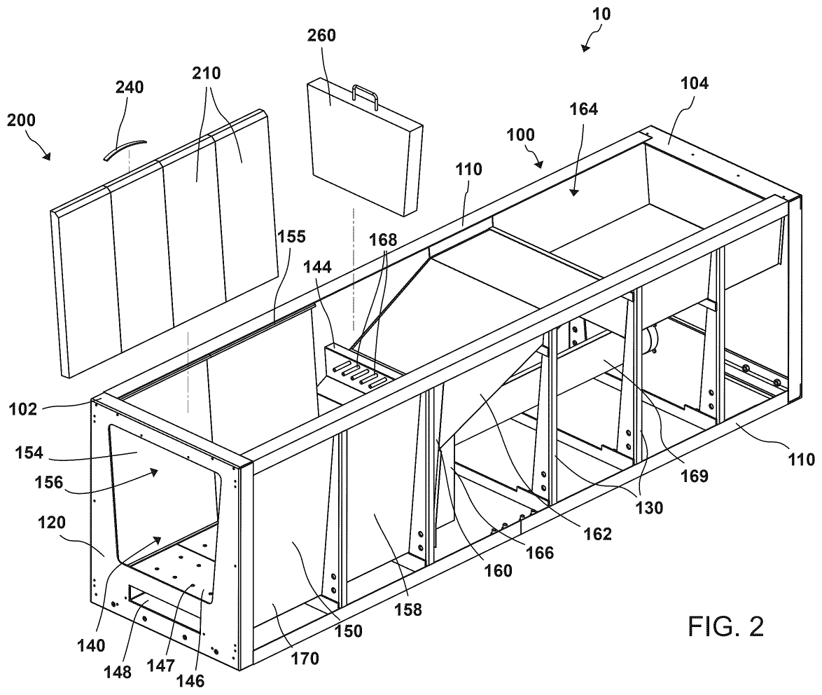

Referring now to FIGS. 1 and 2, in certain embodiments, the combustion chamber frame 100 may define a firebox 140 provided adjacent to the door panel 120 and configured to generate heat through the combustion of a fuel. Examples of suitable fuels may include, for instance, wood, oil, propane, or the like. In the illustrated embodiment, the door panel 120 defines a panel opening 122 sized to enable the insertion of fuel within the firebox 140 for combustion. The door panel 120 may further be configured to mountingly receive one or more doors (not shown) to thermally seal and restrict access to the panel opening 122 and thus the firebox 140 of the combustion chamber frame 100. In certain embodiments, the combustion chamber frame 100 may further include sidewalls 150 extending longitudinally along opposing longitudinal sides of the firebox 140, a transverse wall 160 extending transversally at a distal end 144 of the firebox 140, and a bottom panel 170 extending along a bottom portion of the firebox 140. In such embodiments, the front panel 122, the sidewalls 150, the transverse wall 160, and the bottom panel 170 may delimit the firebox 140 and confine a combustion of the fuel within the firebox 140.

Referring to FIGS. 1, 6 and 7, in certain embodiments, an upper portion 162 of the transverse wall 160 may extend upwardly at an angle from the distal end 144 of the firebox 140 towards the distal end 104 of the combustion chamber frame 100 to define an exhaust conduit 164. More specifically, the exhaust conduit 164 can be defined between the upper portion 162 of the transverse wall 160 and a remaining structure of the evaporator (not shown) to channel exhaust away from the firebox 140. In such embodiments, the exhaust conduit 164 may be fluidly connected to a chimney of the evaporator near the distal end 104 of the combustion chamber frame 100.

In certain embodiments, the transverse wall 160 may further define a plenum 166. The plenum 166 may be substantially enclosed and sized to collect an airflow from an air conduit 169 and to further distribute the airflow into the firebox 140 via a plurality of air inlets 168 provided across the transverse wall 160. In the illustrated embodiment, the combustion chamber 100 includes ten air inlets 168 arranged linearly along a horizontal axis although it will be understood that, in other embodiments, the combustion chamber 100 can include any other number of air inlets 168 arranged in any other suitable manner. In certain embodiments, a distal end of the conduit 169 opposite the plenum 166 may be fluidly connected to an air compressor (not shown) configured to deliver air into the plenum 166.

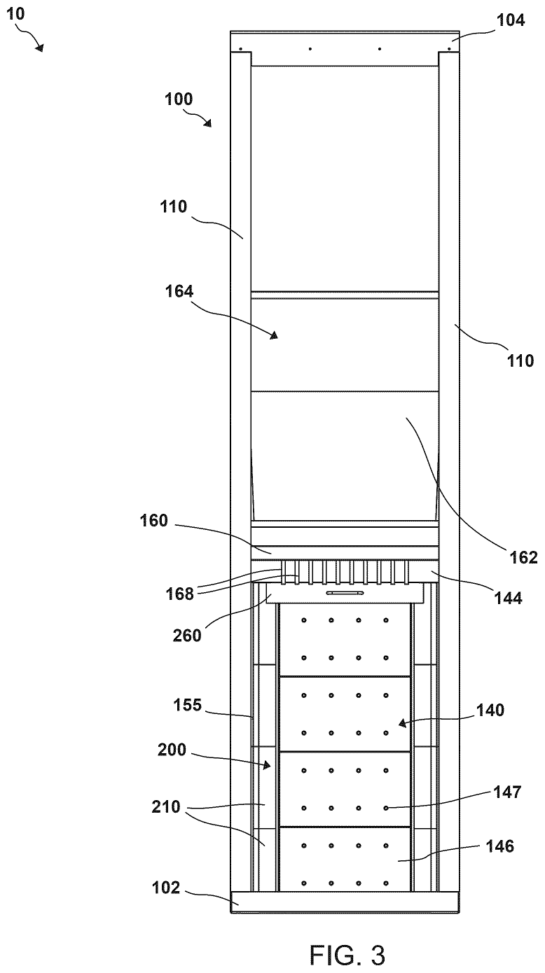

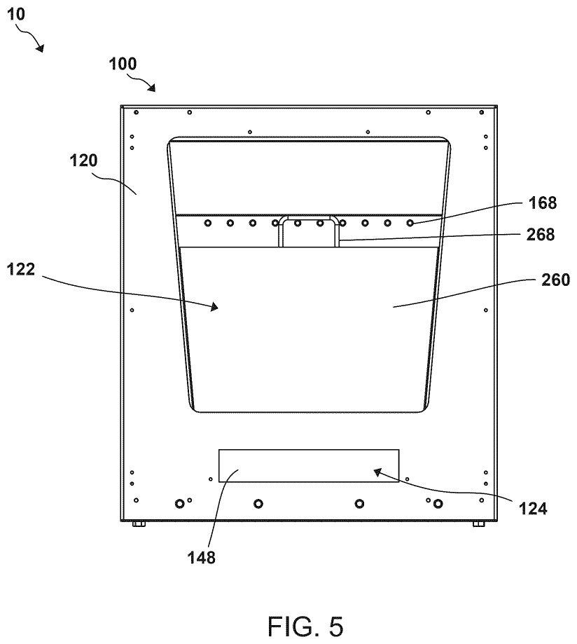

Referring to FIGS. 1 and 3, in certain embodiments, the combustion chambre frame 100 may further include a grate 146 extending substantially horizontally along a bottom portion of the firebox 140. In such embodiments, the grate 146 may serve to at least partially support a solid fuel such as, for instance, wood logs. The grate 146 may be vertically offset from the bottom panel 170 and include a plurality of perforations 147 to define an ash pan 148 beneath the grate 146 configured to collect any combustion byproduct (i.e., ash). In certain embodiments, when the ash pan 148 is fluidly connected to an exterior of the combustion chamber 10, the ash pan 148 may further provide additional airflow to the firebox 140 via the perforations 147. Referring to FIG. 5, in certain embodiments, the door panel 120 may further define a lower opening 124 aligned with the ash pan 148 when the combustion chamber 10 is assembled to facilitate a removal of the combustion byproduct from the ash pan 148.

As stated above, the sidewall 150 can be configured to extend along the longitudinal sides of the combustion chamber frame 100 and to mountingly receive the modular refractory chamber wall 200, as will be described in greater detail below. Referring again to FIGS. 1 and 2, in certain embodiments, the sidewall 150 may include a wall section 152 extending upwardly between the upper and lower structural beams 110. In the illustrated embodiment, the wall section 152 defines a continuous surface devoid of openings between the upper and lower structural beams 110 although it will be understood that, in other embodiments, the wall section 152 can include any number of openings to provide an access across the sidewall 150. In the illustrated embodiment, the wall section 152 includes an inner sidewall 154 and an outer sidewall 156 extending longitudinally along a length of the firebox 140. In other embodiments however, the wall section 152 can extend a greater length (i.e., beyond a length of the firebox 140). In the illustrated embodiment, the structural breams 110 and the sidewall 150 are shown as distinct components of the combustion chamber frame 100. In other embodiments, the sidewall 150 and at least one of structural beams 110 can form a unitary structure with the at least one of the structural beams 110 defining at least a portion of the sidewall 150 of the combustion chamber 100.

Referring now to FIGS. 1 and 2, the combustion chamber 10 includes modular refractory chamber walls 200 extending along opposing longitudinal sides of the firebox 140 to provide a thermal insulation to the combustion chamber 10. In this embodiment, the modular refractory chamber walls 200 includes a plurality of refractory panels 210 that can be assembled together to form each of the modular refractory chamber walls 200. In the illustrated embodiment, each modular refractory chamber wall 200 includes four refractory panels 210 that are positioned adjacent to each other in a lengthwise direction of the combustion chamber frame 100.

It is to be understood that the expression “modular” as used herein refers to a construction of the modular refractory chamber walls 200 using standardized components (i.e., the refractory panels 210) which can provide a flexibility and a variety with respect to the configuration of the modular refractory chamber wall 200. In accordance with some embodiments, the modular refractory chamber walls 200 can be assembled using an initial set of refractory panels 210 and, at a later time, one or more of the refractory panels 210 can be replaced or repaired (for instance, if one of the refractory panels 210 has been damaged or otherwise requires a replacement) by removing, adding and/or rearranging the refractory panels 210 without interfering with or otherwise altering the remaining refractory panels 210. It will thus be appreciated that, as will be demonstrated in the context of various embodiments further below, the modular refractory chamber walls 200 can be rapidly and more readily assembled and/or repaired as compared to a traditional wall of a combustion chamber including refractive bricks assembled using mortar.

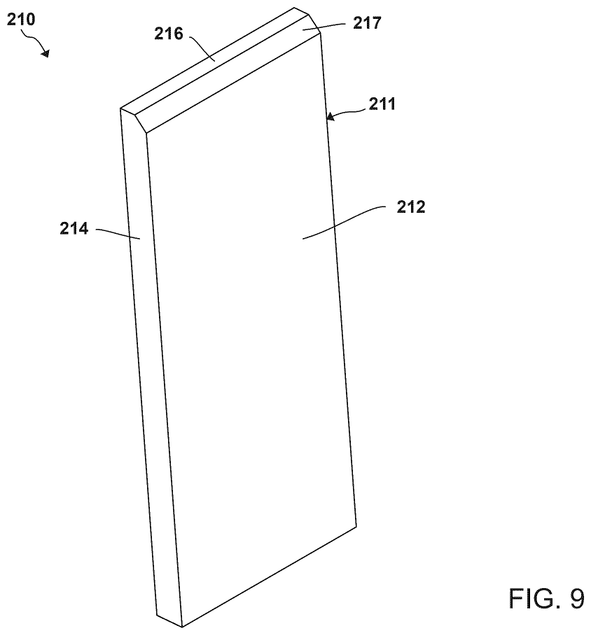

Referring now to FIG. 9, a refractory panel 210 is shown in accordance with an embodiment. In this embodiment, the refractory panel 210 includes a panel body 211 shaped as a rectangular prism having substantially planar opposing primary faces 212 and lateral side faces 214. In certain embodiments, an upper edge 216 of the refractory panel 210 can include a chamfer 217 to promote a mounting of the refractory panel 210, as will be described in greater detail below.

As stated above, the refractory panels 210 can be configured to provide a thermal insulation to the combustion chamber 10. More specifically, the refractory panels 210 can have a low thermal conductivity to reduce heat loss through the sidewalls 150 of the combustion chamber frame 100 and retain heat into the firebox 140 to maintain stable combustion temperatures in the combustion chamber 10. Accordingly, in certain embodiments, the refractory panel 210 can be constructed of a silica-alumina composite material. In certain embodiments, the refractory panel 210 can further include at least one of iron oxide and lime. For instance, in certain embodiments, the refractory panel 210 can be a silica-alumina composite including about 40% to 45% weight of silica, about 35% to 40% weight of alumina, about 3% to 5% weight of iron oxide, and about 10% to 13% weight of lime. In some embodiments, the refractory panel 210 can have a thermal conductivity of about 5.2 BTU·in/(hr·ft²·° F.) at 500° F., about 5.6 BTU·in/(hr·ft²·° F.) at 1000° F., and about 5.9 BTU·in/(hr·ft²·° F.) at 1500° F. In certain embodiments, the refractory panel 210 may have a negligible permanent linear change after drying at 230° F., a permanent linear change of about 0.0 to −0.2% at 1500° F. and of about 0.1 to −1.1% at 2300° F. according to ASTM C-401 (Class B). It will be appreciated that the above stated properties of the refractory panels 210 may further improve their resistance to cracking or breaking under rapid heating and cooling cycles.

Referring again to FIGS. 1 and 2, each of the modular refractory chamber walls 200 can be removably mounted to a corresponding sidewall 150. More specifically, each of the refractory panels 210 of a given modular refractory chamber wall 200 can be removably mounted to the sidewall 150 in a substantially upright mounted configuration and retained in this configuration when mounted. To facilitate a retention of the refractory panels 210, in the illustrated embodiment, the inner sidewall 155 defines a panel-receiving recess 156 shaped and sized to removably receive one or more of the refractory panels 210 in the mounted configuration. In certain embodiments and as shown in the illustrated embodiment, the sidewall 150 of the combustion chamber frame 100 may extend upwardly at angle with respect to a vertical axis. In such embodiments, the associated panel-receiving recess 155 may be shaped to receive the at least one refractory panel 210 of the modular refractory chamber wall 200 in an inclined mounted configuration.

In certain embodiments, the refractory panels 210 can be freestanding (i.e., not affixed or secured to any adjacent structure) when in the mounted configuration. Alternatively, in other embodiments, the combustion chamber 10 may include a panel retaining feature configured to securely retain the refractory panels in the mounted configuration. For instance, in certain embodiments, the combustion chamber 10 may include a resilient member 240 insertable between a side face 214 of the refractory panel 210 and a face of the sidewall 150 opposite the refractory panel 210 when the combustion chamber 10 is assembled to retain the refractory panel in the mounted configuration. In the illustrated embodiment, the inner sidewall 154 includes an upper lip 155 extending substantially horizontally inwardly towards a center of the firebox 140 to be positioned opposite an upper edge 216 of the refractory panel 210 when the combustion chamber 10 is assembled. In this manner, when the resilient member 240 is positioned between the upper edge 216 of the refractory panel 210 and the upper lip 155 of the inner sidewall 154, the resilient member 240 can apply a downward compressive retention force pressing against the refractory panel 210 to retain it in the mounted configuration.

Configured in this manner, a given one of the refractory panels 210 may be retained indefinitely in the mounted configuration when compressed by the resilient member 240. In certain embodiments, the resilient member 210 may be only partially compressed when the combustion chamber 10 is assembled. If a release of the refractory panel 210 is desired, the resilient member 210 may be further compressed to reduce the downward retention force applied to the refractory panel 210 enabling its removal.

In the illustrated embodiment, the resilient member 240 is illustrated as a leaf spring insertable between the upper edge 216 of the refractory panel 210 and the upper lip 185 of the inner sidewall 154 although it will be understood that, in other embodiments, the resilient member 240 can include any other resilient element including a helical compression spring or a compressible material, among others. Moreover, it will be understood that, in certain embodiments, the resilient member 240 can be secured to either of the refractory panel 210 and the sidewall 150 of the combustion chamber frame 100 to facilitate an installation of the refractory panel 210.

In certain embodiments, each of the refractory panels 210 can have a height and width sized to provide a thermal resistance across a desirable surface area of the sidewall 150 of the combustion chamber frame 100. For instance, in certain embodiments, each of the refractory panels can have a height extending over a majority of a height of the sidewall 150. More specifically, in certain embodiments, each of the refractory panels 210 can have a height of about 60 cm to about 80 cm, about 66 cm to about 78 cm, or about 74 cm. Moreover, in certain embodiments, each of the refractory panels 210 can have a width of about 20 cm to about 30 cm, about 25 cm to about 35 cm, or about 30 cm. Accordingly, in certain embodiments, each of the refractory panels 210 can have a surface area of about 2,000 cm² to about 2,400 cm², about 2,100 cm² to about 2,300 cm², or about 2,220 cm². It will be appreciated that providing a refractory panel 210 with a greater surface area may reduce the number of refractory panels 210 required for a given firebox 140 of a combustion chamber 10, thereby facilitating the installation of the combustion chamber 10 and reducing a time of installation.

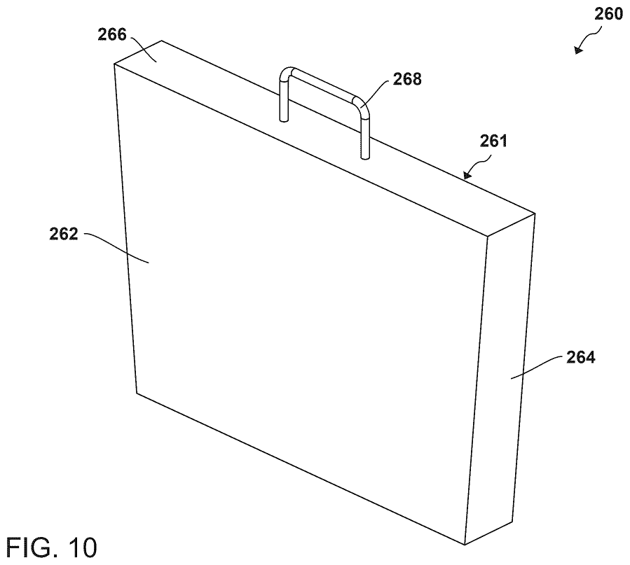

In certain embodiments, the combustion chamber 10 may further include a transverse refractory panel 260 removably mountable to the combustion chamber frame 210 at the distal end 144 of the firebox 140 to provide a secondary thermal insulation to the combustion chamber 10. Referring now to FIG. 10, a transverse refractory panel 260 is shown in accordance with an embodiment. In this embodiment, the transverse refractory panel 260 includes a panel body 261 shaped as a prism sized to extend a width corresponding substantially to a width of the firebox 140. The panel body 261 of the transverse refractory panel 260 has substantially planar opposing primary faces 262, lateral side faces 264 and transverse side faces 266. In certain embodiments, the lateral side faces 264 of the transverse refractory panel 260 extend upwardly away from one another to provide a shape of the transverse refractory panel 260 that corresponds substantially to a transverse cross-sectional shape of the firebox 140. In certain embodiments, the transverse refractory panel 260 can include a handle 268 extending upwardly from an upper one of the transverse side faces 266 of the transverse refractory panel 260 to facilitate the transportation, installation and/or removal of the transverse refractory panel 260.

It will be understood that although the transverse refractory panel 260 is illustrated and described as a unitary refractory panel, the transverse refractory panel 260 may, in other embodiments, have a modular construction similar to the modular refractory chamber wall 200 described above, including a plurality of transverse panel modules (not shown).

Referring again to FIG. 1, in certain embodiments, the transverse refractory panel 260 can be sized for positioning beneath the air inlets 168 of the transverse wall 160 when installed within the combustion frame 100 to enable an unrestricted flow of air into the firebox 140 during use.

It will be understood that although the present modular refractory chamber wall 200 has been described including refractory panels 210 positioned in a substantially upright mounted configuration, in other embodiments, the modular refractory chamber wall 200 can include refractory panels configured to be mounted along a substantially longitudinal direction of the combustion chamber frame 100 with adjacent ones of the refractory panels being stacked on top of one another.

To provide a more concise description, some of the quantitative expressions provided herein are qualified with the term “about”. It will be understood that whether the term “about” is used explicitly or not, every quantity recited herein is meant to refer to an actual given value, and it is also meant to refer to the approximation to such given value that would reasonably be inferred by a person of ordinary skill in the art, including approximations due to the experimental and/or measurement conditions for such given value.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A combustion chamber for an evaporator configured for the production of a syrup, the combustion chamber comprising:
a combustion chamber frame defining a firebox configured to receive a fuel for combustion; and
a modular refractory chamber wall extending along a longitudinal side of the firebox, the modular refractory chamber wall comprising at least one refractory panel removably mountable to the combustion chamber frame to provide a thermal insulation to the combustion chamber.

2. The combustion chamber of claim 1, further comprising a resilient member insertable between a surface of the at least one refractory panel and an opposing surface of the combustion chamber frame when the at least one refractory panel is mounted to the combustion chamber frame to retain the at least one refractory panel in a mounted configuration.

3. The combustion chamber of claim 2, wherein the resilient member is insertable between an upper side face of the at least one refractory panel and an upper lip of the combustion chamber frame.

4. The combustion chamber of claim 2, wherein, when the combustion chamber is assembled, the resilient member is partially compressed and configured to enable a release of the at least one refractory panel from the combustion chamber frame when fully compressed.

5. The combustion chamber of claim 1, wherein the modular refractory chamber wall comprises a plurality of refractory panels configured to be removably mounted to the combustion chamber frame in an adjacent configuration.

6. The combustion chamber of claim 5, wherein the modular refractory chamber wall is a first modular refractory chamber wall, and the longitudinal side of the firebox is a first longitudinal side of the firebox, the combustion chamber further comprising a second modular refractory chamber wall extending along a second longitudinal side of the firebox opposite the first longitudinal side of the firebox.

7. The combustion chamber of claim 1, wherein the combustion chamber frame comprises a sidewall configured to mountingly receive the modular refractory chamber wall.

8. The combustion chamber of claim 7, wherein the sidewall of the combustion chamber frame comprises an inner sidewall and an outer sidewall, the at least one refractory panel being removably mountable to the inner sidewall.

9. The combustion chamber of claim 7, wherein the sidewall defines a panel-receiving recess sized to receive the at least one refractory panel of the modular refractory chamber wall.

10. The combustion chamber of claim 9, wherein the panel-receiving recess extends over a majority of a height of the sidewall of the combustion chamber frame.

11. The combustion chamber of claim 9, wherein the panel-receiving recess is shaped to receive the at least one refractory panel of the modular refractory chamber wall in an inclined configuration.

12. The combustion chamber of claim 1, wherein the at least one refractory panel is a silica-alumina composite.

13. The combustion chamber of claim 1, wherein the at least one refractory panel comprises at least 40% by weight of alumina.

14. The combustion chamber of claim 13, wherein the at least one refractory panel is a silica-alumina composite further comprising at least one of iron oxide and lime.

15. The combustion chamber of claim 1, wherein the at least one refractory panel has a permanent linear change of about 0.1 to −1.1% after heating to 2300° F. according to ASTM C-401 (Class B).

16. The combustion chamber of claim 1, further comprising a transverse refractory panel removably mountable to the combustion chamber frame at a distal end of the firebox of the combustion chamber frame to provide a secondary thermal insulation to the combustion chamber.

17. The combustion chamber of claim 16, wherein the transverse refractory panel comprises a handle extending upwardly to facilitate a removal of the transverse refractory panel from the combustion chamber.

18. The combustion chamber of claim 16, wherein the transverse refractory panel extends a width of the firebox when mounted to the combustion chamber frame.

19. A refractory panel configured for installation in the combustion chamber according to claim 1.

20. A method of installing a modular refractory chamber wall in a combustion chamber of an evaporator, the method comprising:
removably mounting a refractory panel of the modular refractory chamber wall to a combustion chamber frame of the combustion chamber; and
inserting a resilient member between the refractory panel and the combustion chamber frame to compressively retain the refractory panel in a mounted configuration.
